(19) United States
(12) Patent Application Publication
(10) Pub. No.: US 2023/0311446 A1
(43) Pub. Date: Oct. 5, 2023

(54) ADDITIVE-CONVEYING LAMINATE LAYER

(71) Applicant: LOUISIANA-PACIFIC CORPORATION, Nashville, TN (US)

(72) Inventors: G. PAUL MERRICK, GIG HARBOR, WA (US); JIANWEN NI, FRANKLIN, TN (US); LANCE OLSON, Saginaw, MN (US)

(21) Appl. No.: 18/129,806

(22) Filed: Mar. 31, 2023

Related U.S. Application Data
(60) Provisional application No. 63/326,161, filed on Mar. 31, 2022.

(51) Int. Cl. B32B 5/02; B32B 21/02; B32B 21/10; E04C 2/24; E04C 2/52

(52) U.S. Cl. CPC B32B 5/022; B32B 21/02; B32B 21/10; E04C 2/24; E04C 2/526; B32B 2260/028; B32B 2260/046; B32B 2307/3065; B32B 2262/101; B32B 2262/02; B32B 2262/062; B32B 29/02

(57) ABSTRACT

A manufactured wood panel or board with an integrated conveying laminate that conveys a fire resistant (FR) additive to specific locations within the panel or board during the manufacturing process, and the process and system for producing a panel or board with an FR conveying laminate. The laminate may be a natural or synthetic material with a closed (i.e., solid) or open (i.e., mesh-like) surface. In addition to providing resistance to fire spread and fire combustion, the laminate also may be selected from a group of materials that produce desired structural properties (i.e., minimize cracking, enhance structural integrity) both before and during a particular event, such as a fire event.

This application claims benefit or and priority to U.S. Provisional Application No. 63/326,161, filed Mar. 31, 2022, which is incorporated herein by specific reference for all purposes.

### FIELD OF INVENTION

This invention relates to a laminate to carry or convey additives, including but not limited to fire-resistant and flame-resistant additives, into or onto a wood composite matrix or panel.

### BACKGROUND OF THE INVENTION

Building wall and roof assemblies are commonly comprised of layers of several materials, each performing a specific function, that are installed separately. A typical assembly for residential home wall construction would include a dimension lumber frame, a plywood or oriented strand board (OSB) sheathing layer and a siding. In some cases, the sheathing and siding can be the same layer, such as a panel siding that is code approved as a sheathing. Wood-based composites, such as OSB, are code approved alternatives to veneer-based wood paneling (e.g. softwood plywood).

In general, wood-based panel composites include oriented strand board (OSB), laminated strand lumber (LSL), wafer board, flake board, particle board as well as medium density fiberboard (MDF). These wood-based composites are typically formed from a wood material combined with a thermosetting adhesive to bind the wood substrate together. In some processes, the adhesive is combined with other additives to impart additional properties to the wood composites. Additives can include fire retardants, fungicides/mildewcides, insecticides and water repellents. These ingredients can also be added separately from the adhesive, for example when this is more compatible with the manufacturing process. A significant advantage of strand and particle-based wood composites is that they have many of the properties of plywood and dimension lumber but can be made from a variety of lower grade wood species, smaller trees and waste from other wood product processing, and can be formed into panels in lengths and widths independent of size of the harvested timber.

One class of alternative products are multilayer oriented wood strand board products, particularly those with a targeted layer-to-layer oriented strand pattern, such as OSB. These oriented strand, multilayer composite wood panel products are composed of several layers of thin wood strands, which are wood particles having a length which is several times greater than their width. These strands are created from debarked round logs by placing the edge of a cutting knife parallel to a length of the log and then slicing thin strands from the log. The result is a strand in which the fiber elements are substantially parallel to the strand length. These strands can then be oriented on the mat-forming line with the strands of the face layers predominantly oriented in a parallel to machine direction orientation and strands in the core layer oriented, generally, perpendicular to the face layers (e.g., cross-machine) direction.

In one common commercial process these layers are bonded together using natural or synthetic adhesive resins under heat and pressure to make the finished product. Oriented, multilayer wood strand boards of the above-described type can be produced with mechanical & physical properties comparable to those of commercial softwood plywood and are used interchangeably, such as for wall and roof sheathing. In certain types of construction, these panels (and other construction materials) may be required by building codes to meet certain durability requirements, such as fire, decay, insect, wind and water resistance.

Oriented, multilayer wood strand boards of the above-described type, and examples of processes for pressing and production thereof, are described in detail in U.S. Pat. Nos. 3,164,511, 4,364,984, 5,435,976, 5,470,631, 5,525,394, 5,718,786, and 6,461,743, all of which are incorporated herein in their entireties by specific reference for all purposes.

Engineered wood siding and trim are specialty grades of oriented strand board that may be attached over sheathing or directly to the wall framing (e.g. in place of sheathing). These products have enhanced properties to perform under exposed, exterior weathering applications. The enhancements may include, but are not limited to, the type and amount of adhesive, the addition of water repellants and preservatives and the application of a resin saturated paper overlay to one or more sides. Engineered wood siding or trim may also be used, for example, as a fencing product with appropriate modifications to the manufacturing process described above.

During a fire event, natural wood and engineered wood composite products can crack and split, causing them to lose structural integrity and allowing the fire to more deeply penetrate into the building assembly (e.g. an exterior wall exposed to a wildfire). Typical resin-impregnated paper overlays designed and used for exterior exposure (e.g., as used with engineered wood based composite siding) do not provide fire resisting or structural reinforcing properties to the underlying oriented strand board substrate. Overlays that do have fire resisting properties are typically limited to interior uses, where exposure to weather and resulting conditions (e.g., moisture) will not negatively impact functional additives. Intumescent additives, for example, can negatively impact paint finishes and become ineffective in a fire event (see, e.g., Dion et. al., U.S. Pat. No. 8,808,850, which is incorporated herein by specific reference for all purposes). These fire resistant (FR) overlays typically contain ingredients that are not compatible with commercial hot-press processes, such as those used to manufacture engineered wood siding and trim. Furthermore, the underlying Kraft paper, even when saturated with resins, is not capable of, nor designed to, limit or reduce cracking of the underlying strand substrate during a fire event (i.e., it has inadequate structural reinforcing properties).

### SUMMARY OF THE INVENTION

In various exemplary embodiments, the present invention comprises an improved process and system for producing a wood-composite panel or board. Unlike prior art systems where additives are blending with wood strands or flakes prior to formation of a multi-layer mat, which is then subjected to heat and pressure in a high-temperature press, the present invention uses a laminate to convey the additives into or onto the wood composite matrix or mat prior to pressing.

The laminate may be a natural or synthetic material with a closed (i.e., solid) or open (i.e., mesh-like) surface. Depending on the manufacturing process, the laminate may be selected from a group of materials that produce desired structural properties (i e, minimize cracking, enhance structural integrity) both before and during a particular event, such as a fire event. Thus, for example, a fiberglass mat or fiberglass-like material may be used, tightly woven or less tightly woven. A mat may also be composed of a non-woven fabric of various weight, layers, and porosity (sometimes referred to as “wool”). A mesh may be used to enhance structural integrity. Examples of suitable conveying material include, but are not limited to, Kraft paper (saturated and unsaturated), fiberglass and similar glass-like materials, and woven and non-woven polymers.

The use of a laminate eliminates the inefficiency of blending the additives with strands or flakes, and allows for the targeted use of those additives, putting them more precisely where they are needed, on or in the product. Further, the present invention allows targeted blending or mixing of multiple additives at ratios that maximize performance while optimizing costs.

In one exemplary embodiment, the additives include fire and/or flame reducing or resistant additives. The additives may vary in nature and composition (e.g., solid, liquid). Liquids may be of varied viscosities, and may include gels. Additives may be dry or semi-dry particles or a sprayable dispersion that adhere to or coat the laminate through natural attraction or the use of a compatible adhesive or adhering substance. An additive may be intumescent or non-intumescent or a combination thereof. Additives may also be naturally resistant to combustion and/or flame propagation across a surface.

Blends of additives of different compositions are possible, including blends that provide synergistic performance. Blends may be customized to cost efficiently meet the end use performance requirement. Examples include but are not limited to; borate salts and oxides (e.g., zinc borate), boric acid, fly ash (e.g., oxides of silica and calcium), clay (e.g., kaolin), aluminum oxide, magnesium oxide, titanium oxide, cerium oxide, ceramics and modified or treated cellulose.

Additives may be applied to the laminate material prior to use (i.e., pre-applied to the laminate), or applied to the laminate during the wood composite substrate manufacturing process. When applied in the latter fashion, the additives may be applied and conveyed by the laminate just prior to entering the press. Alternatively, the additives may be applied and conveyed by the laminate in a secondary process after the hot press.

The additives may be added to the top and/or bottom of the laminate, and multiple laminates may be used. Additives may be added to the bottom or top of the laminate when the laminate is an underlay. Additives may be added to the bottom of the laminate when the laminate is used immediately on top of the mat of strands. Additives may be added to the top face of an underlay when two laminates are used (e.g., a sandwich effect).

### BRIEF DESCRIPTION OF THE DRAWINGS

FIG. 1 shows a cross-sectional diagram of an additive-conveying laminate product in accordance with the present invention, with the laminate disposed between a strand matrix and performance overlay.

FIG. 2 shows a cross-sectional diagram of an additive-conveying laminate product in accordance with another exemplary embodiment of the present invention, with the laminate disposed between a strand matrix and a fines layer with overlay.

FIG. 3 shows a cross-sectional diagram of a pre-finished additive-conveying laminate product in accordance with another exemplary embodiment of the present invention.

FIG. 4 shows a cross-sectional diagram of a pre-finished double additive-conveying laminate product in accordance with another exemplary embodiment of the present invention.

FIG. 5 shows a cross-sectional diagram of a wrapping additive-conveying laminate product in accordance with another exemplary embodiment of the present invention.

FIG. 6 shows a cross-section of a product with a two-layer laminate.

FIG. 7 shows a cross section of a product with an upper laminate with infused FR additive, and a bottom laminate with surface FR additives.

FIG. 8 shows a cross section of a product with an upper laminate with absorbed FR additive.

FIG. 9 shows a diagram of a production process for making a conveying laminate product.

FIG. 10 shows a diagram of an alternative production process for making a conveying laminate product.

FIG. 11 shows a diagram of another alternative production process for making a conveying laminate product.

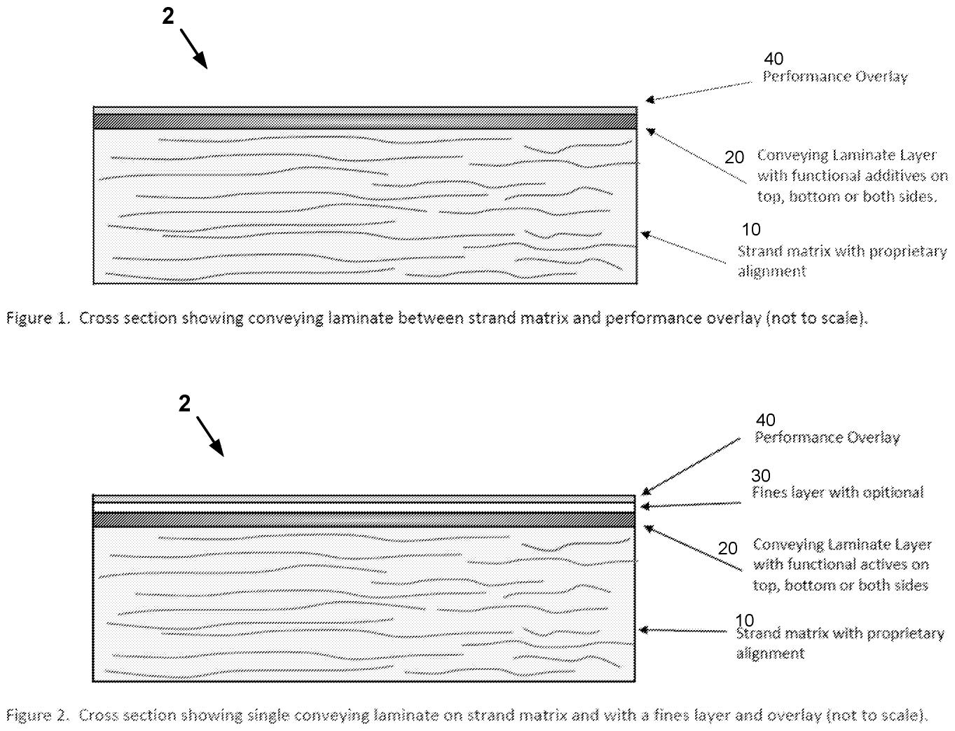

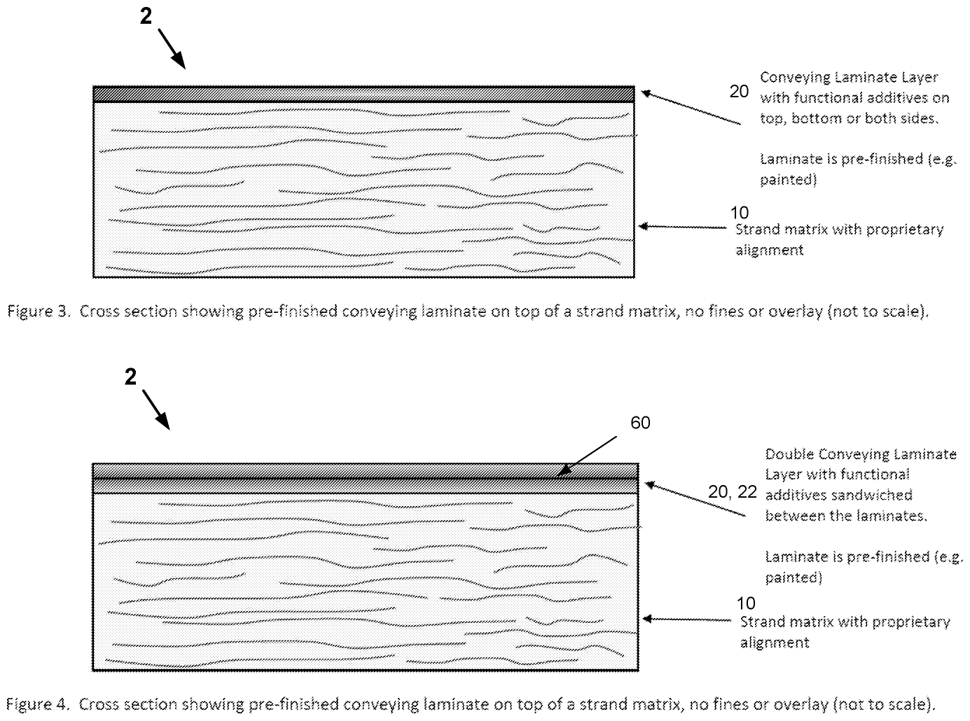

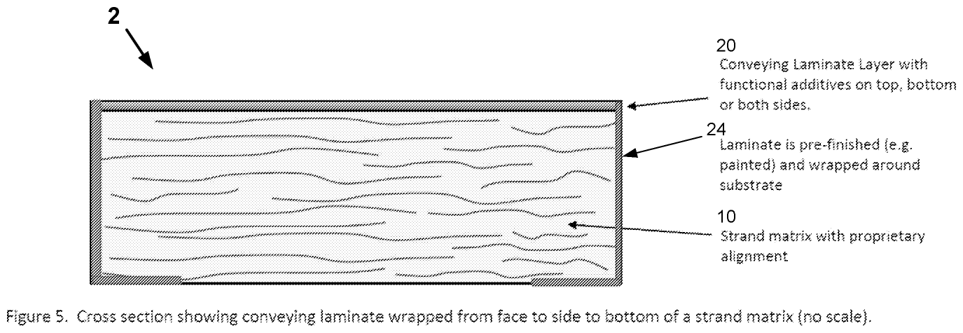

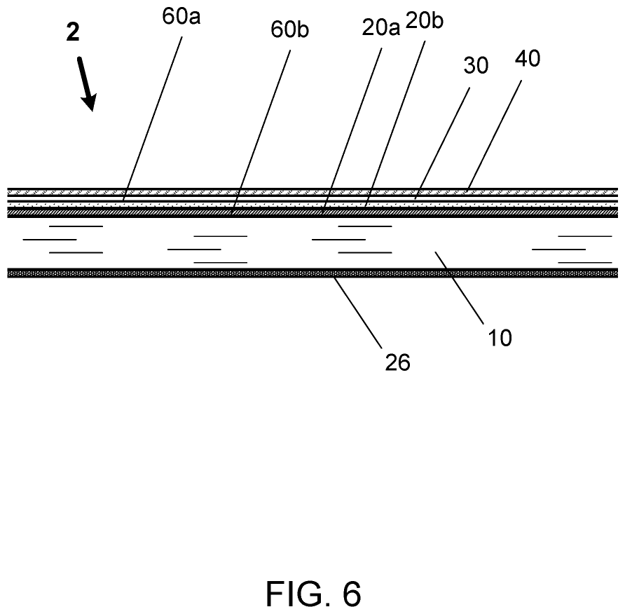

### BRIEF DESCRIPTION OF INVENTION

In various exemplary embodiments, the present invention comprises an improved process and system for producing a wood-composite panel or board 2. Unlike prior art systems where additives are blending with wood strands or flakes prior to formation of a multi-layer mat, which is then subjected to heat and pressure in a high-temperature press, the present invention using a laminate 20 to convey the additives 60 into or onto the wood composite strand matrix or mat 10 prior to pressing. A fines layer 30 and/or a performance overlay 40, such as a resin-impregnated paper overlay, or water or weather resistant barrier (WRB), may also be applied as known in the prior art. The conveying laminate 30 is typically located underneath any fines layer 30 and/or performance overlay 40.

The conveying laminate 20 in the resulting panel, board, or other product 2 provides resistance to combustion during a fire event (e.g., a wildfire), resistance to flame spread across the panel, board or product surface during a fire event, and/or resistance to the substrate (e.g., the underlying engineered wood substrate) cracking or otherwise losing structural integrity during a fire event. A single laminate may comprise one or more types of materials, and one or more layers 20a, 20b of material. A single laminate may be used with a panel, board or engineered-wood product, although multiple laminates may be used with a panel, board or engineered-wood product in some embodiments.

A laminate may comprise a natural or synthetic material with a closed (i.e., solid) or open (i.e., mesh-like) surface. The laminate may comprise multiple types of material, including multiple natural type combinations, multiple synthetic type combinations, and/or natural and synthetic type combinations. As discussed below in further detail, materials may have inherent FR properties and/or treatment-related FR properties. Materials selected also may have structural reinforcement properties.

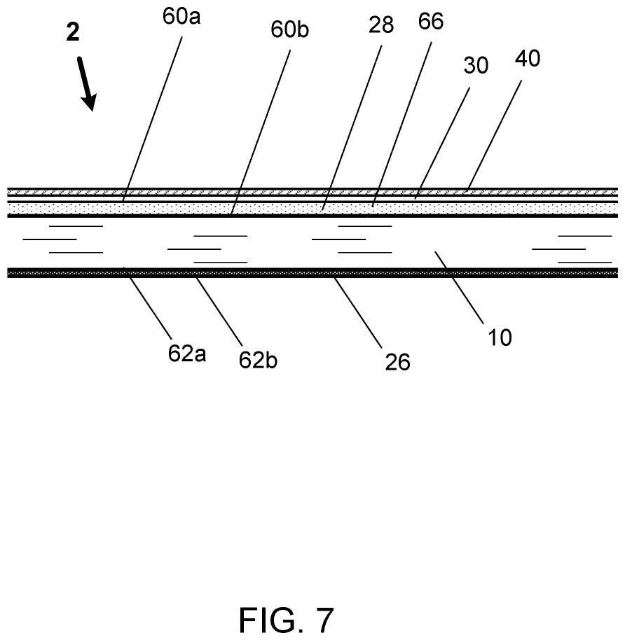

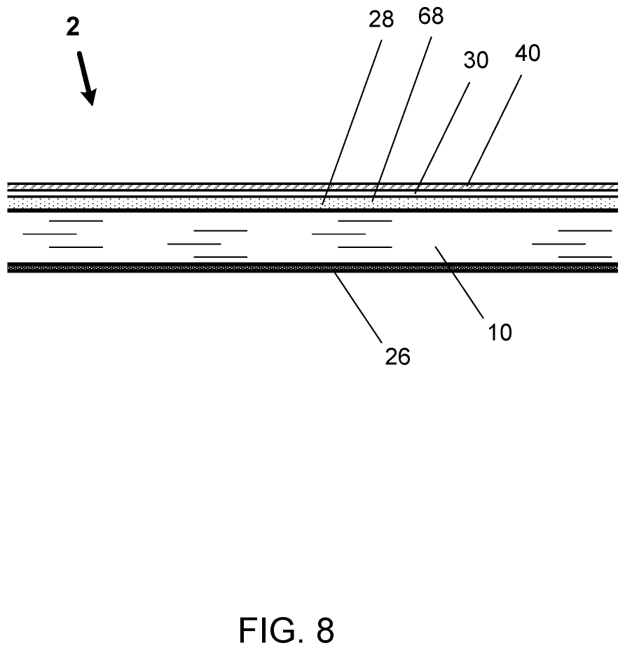

The laminate also may comprise one or multiple layers 20a, 20b. The laminate thus may comprise multiple layers, each layer comprising the same material type, a different material type, or combinations thereof (e.g., as seen in FIG. 7, a three layer laminate with the center layer 20b may comprise a material different from the two outer (top and bottom) layers 20a, c, while the two outer layers may comprise the same material or different materials between themselves).

In some embodiments, multiple laminates are used in the same panel, board or product, as seen in FIG. 7. For example, a dual laminate configuration may be used, where each laminate 20, 22 is a single layer of material, and each comprises the same material type. Alternatively, each laminate may be a single layer of material, but each comprises a different material type 20, 26. Other combinations also may be used: e.g., a first laminate is a single layer, while the second laminate comprises multiple layers, or vice-versa. The layers within a laminate, and the different laminates, can thus be arranged and configured to achieve desired effects depending on the materials and FR properties, a layer's position in a laminate relative to other layer(s), and a laminate's position in the panel, board or product relative to other laminates and panel or board components (e.g., engineered-wood flakes, woods-based fines, and the like).

Examples of suitable conveying material include, but are not limited to, Kraft paper (saturated and unsaturated), fiberglass and similar glass-like materials, and woven and non-woven polymers. Depending on the manufacturing process, the laminate may be selected from a group of materials that produced desired structural properties (i e, minimize cracking, enhance structural integrity) both before and during a particular fire event, such as a wildfire event. Thus, for example, a fiberglass mat or fiberglass-like material may be used, tightly woven or less tightly woven. A mat may also be composed of a non-woven fabric of various weight, layers, and porosity (sometimes referred to as “wool”). A mesh may be used to enhance structural integrity.

Natural materials for use in a conveying laminate of the present invention include, but are not limited to, cellulose and non-cellulose materials. Examples include, but are not limited to, hardwood, softwood, liner board, paper board, cotton, jute, hemp, bagasse, bamboo, lyocell materials (e.g., processed cellulose; rayon) blended or not blended with other fibers, modal (e.g., beech wood speciality cellulose), glass fiber, fiberglass, mineral fiber, silica, and the like, and combinations thereof. Synthetic materials for use in a conveying laminate include, but are not limited to, nylon, polyester, aramid (para, meta), modacrylic (e.g., long chain acrylonitrile), melamine, carbon fiber, silica/boron blend(s), silica/aramid blends, and the like, and combinations thereof.

Conveying laminate materials may include woven and non-woven fabrics. Examples, include, but are not limited to, knitted fibers, fiber bundles, textiles, various weave types (e.g., twill, plain, and the like), a fire resistance treatment treated as a fabric, non-woven veils or veil cloth (spun-bonded polymer filaments, spun-lace bonded, heat-bonded, air-laid (e.g., pulp), melt-blown, stitch bonded, or combinations thereof), and/or blends or combination thereof. Additional examples include, but are not limited to, two-dimensional or three-dimensional mesh and/or mesh fabric cloth and veils, coated “filmed” fabric, and/or reinforced fabrics (e.g., fiberglass-reinforced polymer). A mesh may be relatively open (i.e., less dense) or relatively closed (more dense).

The use of a laminate or laminates eliminates the inefficiency of blending any additives with strands or flakes, and allows for the targeted use of those additives, putting them more precisely where they are needed, on or in the product. Further, the present invention allows targeted blending or mixing of multiple additives at ratios that can be consistently applied across the product, or with various ratios that are applied to specific areas of or in the product, that maximize performance while optimizing and/or reducing costs.

In one exemplary embodiment, the additives include fire and/or flame reducing or resistant additives. The additives may vary in nature and composition (e.g., solid, liquid, or combinations thereof). Solid additives may comprise particles, granules, dust, and/or similar material, which may be of uniform and/or varied size and of uniform and/or varied shape. Liquids may be of varied viscosities (e.g., viscous, semi-viscous), and include, but are not limited to, gels, solutions, dispersions, suspensions, and/or uncured or undried films. Additives may be combinations of the above, e.g., dry or semi-dry particles that are loose, or with an added tacking/adhesive agent, or a sprayable dispersion that adheres to or coats the laminate through natural attraction or the use of a compatible adhesive or adhering substance.

An additive may be intumescent or non-intumescent or a combination thereof. Additives may also be naturally resistant to combustion and/or flame propagation across a surface. Thus, the additives, and/or the material(s) of the laminate itself, may comprise inherently FR resistant materials, which can physically impede the rate of fire spread and/or combustion, and/or chemically FR resistant materials, which can reactively impede the rate of fire spread and/or combustion. As indicated, impeding can comprise the resistance to or reduction in the rate of flame spread or the rate of combustion, or a combination of both.

Natural and/or manufactured materials with FR properties include, but are not limited to, vermiculite (a mineral containing Mg, Fe, Al and Si), gypsum (calcium sulfate), carbon or graphite (in the form of fibers or nanotubes), perlite (expanded volcanic glass or obsidian, containing SiO₂, Al₂O₃ and/or trace oxides), stone or mineral wood fiber (e.g., basalt), limestone (calcium carbonate), silica (in the form of glass fibers or pumice), calcium silicate, potassium silicate, sodium silicate, aluminum silicate (e.g., kaolin clay), titanium dioxide, boron (in the form of boric acid, borax, boric oxide, sodium borates, and/or zinc borate), magnesium oxide, ammonium polyphosphate (APP), aluminum phosphate (AlPO₄), aluminum hydroxide (Al(OH)₃), melamine (1,3,5-Triazine-2,3,6-triamine), modacrylic, (long chain acrylonitrile), nylons, aramids (aromatic polyamide; para-aramids, meta-aramids), polyester, borosilicates, pentaerythritol, and ammonium pentaborate, or combinations thereof.

Blends of additives of different compositions are possible, including blends that provide synergistic performance. Blends may be customized to cost efficiently meet the end use performance requirement. Examples include but are not limited to; borate salts and oxides (e.g., zinc borate), boric acid, fly ash (e.g., oxides of silica and calcium), clay (e.g., kaolin), aluminum oxide, magnesium oxide, titanium oxide, cerium oxide, ceramics and modified or treated cellulose. In certain embodiments, FR additives do not include asbestos, compounds containing bromates, and/or halogenated compounds, due to the health risks associated with these materials.

Additives may be pre-applied to the laminate material prior to use of the laminate, or applied to the laminate material during the wood composite substrate manufacturing process when the laminate is laid in the multi-layered mat. When applied in the latter fashion, the additives may be applied and conveyed by the laminate at the appropriate points in the manufacturing process, up to just prior to entering the primary press. Alternatively, in some embodiments the additives may be applied and conveyed by the laminate in a secondary process after the primary hot press.

The additives may be added to the top 60a and/or bottom 60b of the laminate, and multiple laminates may be used. Additives may be added to the bottom 62b or top 62a of the laminate where the laminate is an underlay 26 (i.e., located at or near the bottom of the multi-layered mat). Additives may be added to the bottom of the laminate when the laminate is used immediately on top of the multilayered mat. Additives may be added to the respective faces of an underlay or overlay when two adjacent laminates are used (e.g., a sandwich effect), as seen in FIG. 4.

An additive may be mixed with, remain separate, or be fully or partially absorbed into the above-described cellulose or non-cellulose materials (e.g., ash, cement, and the like), prior to application into or onto a laminate. The additive may be a combination or blend thereof.

For example, an additive (or additives) 66 may be infused or impregnated into a laminate structure (e.g., a fabric or mesh laminate), or into the materials and/or components comprising the laminate 28 (e.g., the fibers in the fabric laminate), using pressure process methods or vacuum process methods known in the art, or combinations thereof. An additive (or additives) 68 also may saturate or be absorbed into the materials and/or components comprising the laminate 28 (e.g., the fibers in the fabric laminate), with or without pressure and/or vacuum process methods. Absorption may thus take place at atmospheric or ambient pressure.

In another example, an additive (or additives) may be applied to a surface of the laminate in the form of a low molecular weight solution, gel, viscous or semi-viscous liquid, or fluid. The application methods may include, but are not limited to, immersion (dipping), spraying, curtain-coating, flood-coating, other similar methods known in the art, or combinations thereof. An example of FR laminate of this type is a calcium carbonate coated fiberglass veil, 0.72 mm thick.

An additive (or additives) also may be applied to the surface of the laminate in solid form (e.g., dust, particle, granule, mineral, and the like). The application methods may include, but are not limited to, electrodeposition (or other electrostatic deposition processes), spray or splatter application methods (e.g., HVLP high volume, low pressure, and other “blow-on” processes), gravity deposition, and methods using bonding agents (e.g., the solids are coated with an adhesive or tackifier).

In one embodiment an underlying laminate layer is rolled onto the mat of strands, prior to the press. A bonding agent is used if needed. The additive or additives are deposited, then an overlay material is applied. A preferred overlay material provides moisture protection and a paintable surface for the wood composite product.

In an alternate embodiment, the underlying laminate layer is pre-coated with the additive(s) on its top surface. The outer laminate (as an overlay) is then applied prior to entering the press for consolidation.

In a further embodiment, the underlying laminate, additives and outer laminate are pre-assembled and placed on top of the mat of strands, as appropriate, before entering the press. An alternate approach applies the pre-assembled laminate layer(s) in a secondary process to the consolidated mat after exiting the primary press. In a dual layer approach, the process sandwiches the additive(s) between two layers of laminate (e.g., an underlay and an overlay). Application post-press allows for use as a veneer-like wrap, in which the material can cover the edges and partially cover the back of a finished wood composite, areas critical to end use performance. The underlay and overlay materials may be the same or different.

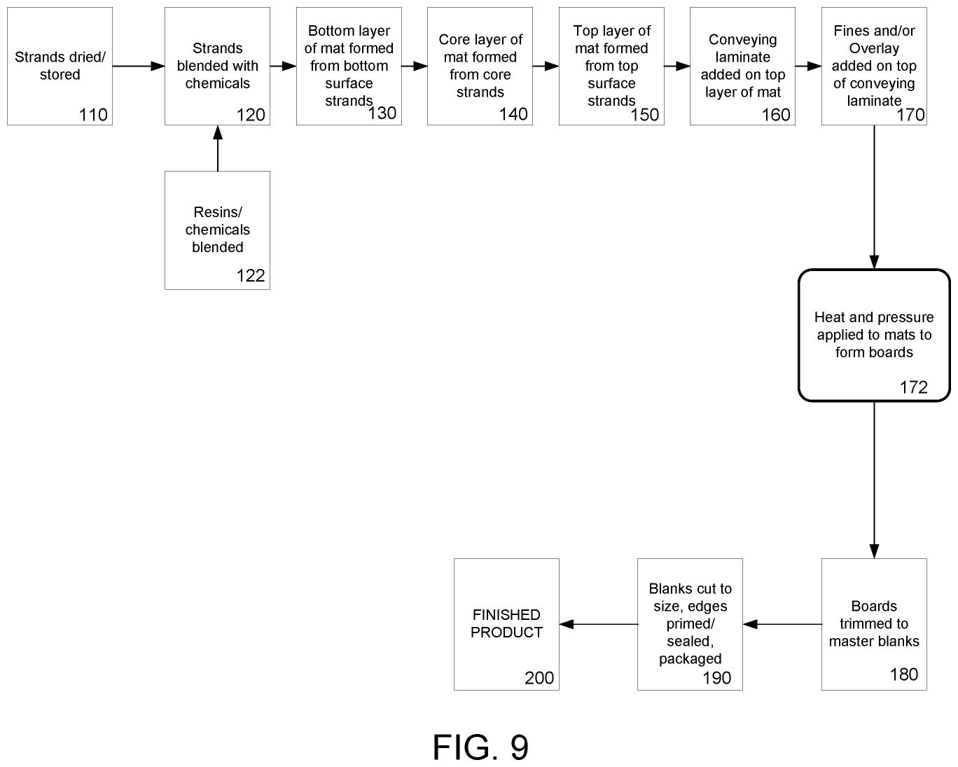

Steps of a manufacturing process in accordance with the present invention using a low temperature press are shown in FIG. 9. These steps include the drying and storing of wood strands 110, the treatment or blending 120 of designated strands (e.g., bottom, core, top, or all strands) with applicable chemicals and/or additives (e.g., wax, resin, and the like) 122, the forming of the appropriate strand layers in order on a forming line (first bottom surface, then core, then top surface) using designated strands, 130, 140, 150, the application of a conveying laminate layer with FR additive on the top layer of the mat 160, the addition of any fines and/or any performance overlay over the conveying laminate layer 170, application of heat and pressure to the mats using a primary press to form boards 172, and subsequent trimming 180 and processing (e.g., panels cut to size, edges primed/sealed, and packaging) 190 to produce the finished product 200. The conveying laminate step 160 may comprise the application of two or more laminates as described above.

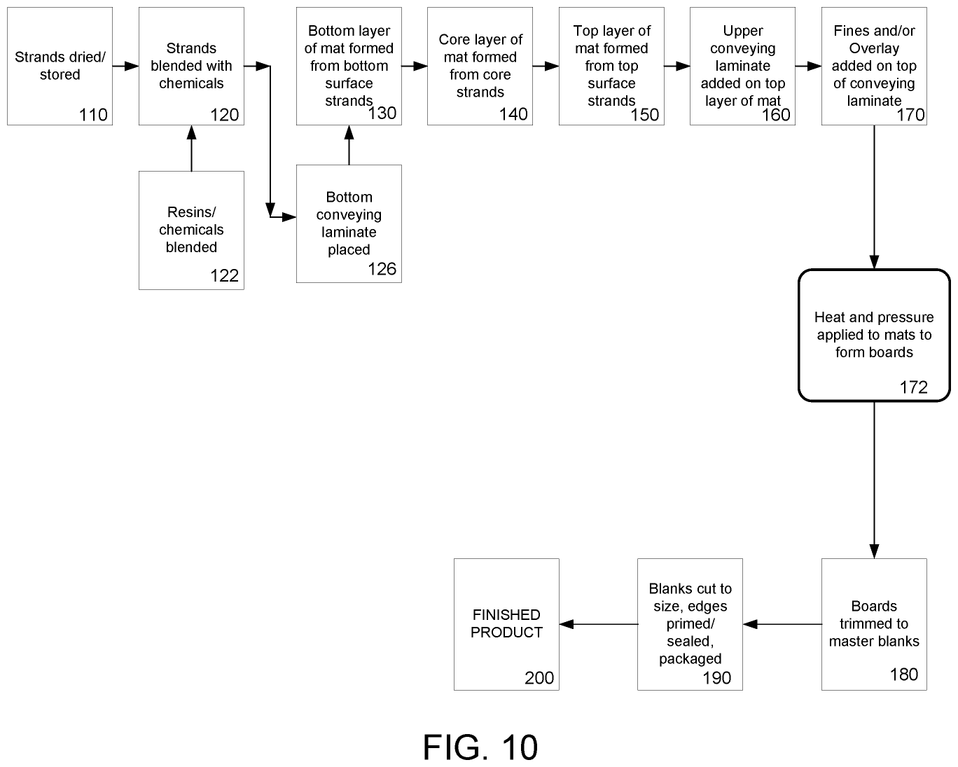

FIG. 10 shows the steps of a variation of the above manufacturing process, wherein a bottom laminate with FR additive is first placed so as to be the bottommost layer of the mat, such that laminate layers are present on both sides of the strand layers (placed by steps 126 and 160). In some embodiments, the upper laminate step 160 may be skipped, or may comprise the application of two or more laminates as described above.

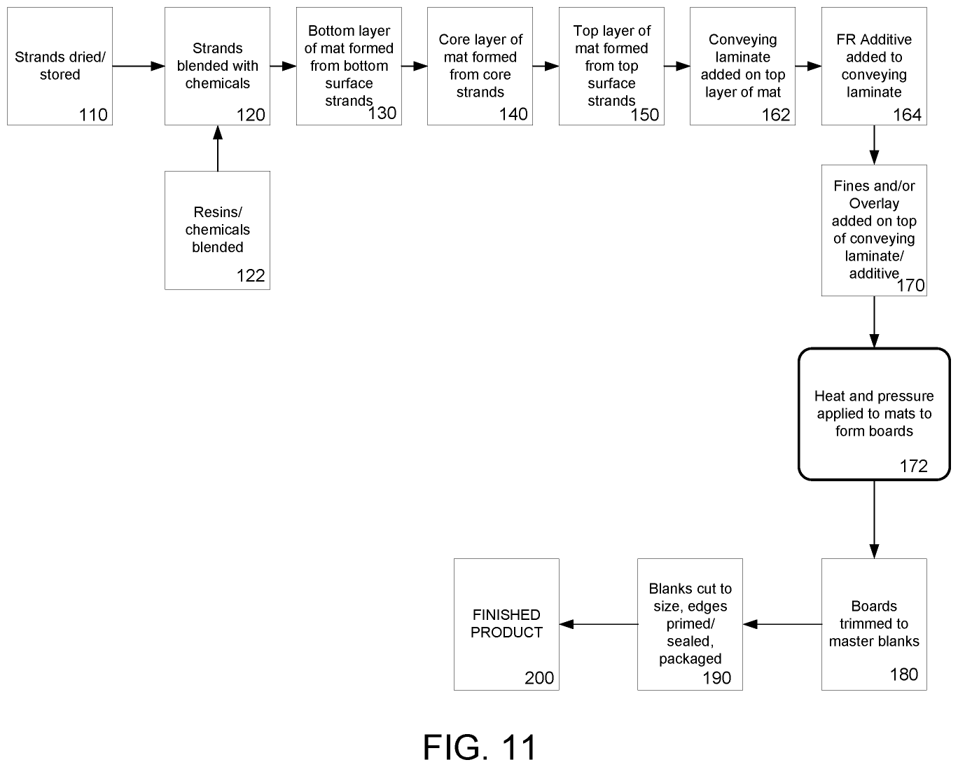

FIG. 11 shows the steps of another variation of the above manufacturing process, wherein the laminate is initially placed 162 on the top layer of the mat without an FR additive, and is followed by the step of applying an FR additive to the laminate or on the upper surface of the laminate 164, as described above.

An advantage of the present invention is that the manufacturer can easily change the composition and weight of the additive or additives, optimizing for different end use applications, without substantial modification of the production line or process itself. The changes are engineered into the conveying laminate(s), which are applied as described above with no changes required in the production line itself.

Specific examples of laminates include, but are not limited to, the following:
(a) FR resistant polyester mesh, weight 3.31 oz/yd2 (10 g/ft2).
(b) Heat Set Fire Resistant polyester spacer-mesh, weight 16 oz/yd2 (50 g/ft2).
(c) Polyester surfacing veil, 10 mil (0.010″) thick, weight 1.2 oz/yd2 (3.2 g/ft2).
(d) Non-woven carbon fiber veil, 2-3 mil (0.002-0.003″) thick, weight 0.20 oz/yd2 (0.63 g/ft2).
(e) Unidirectional carbon fabric, 6 mil (0.006″) thick, weight 4 oz/yd2 (13 g/ft2).
(f) Cross twill weave fiberglass fabric (filament yarns), 0.4 mm thick, weight 38 to 42 g/ft2.
(g) 3D fiberglass fabric, standard thicknesses and weights: 3 mm, 780 g/m2; 5 mm, 840 g/m2; 8 mm, 930 g/m2; 10 mm, 1430 g/m2.
(h) Flexible fiberglass veil (thickness/weight): 10 mil, 3.5 g/ft2; 20 mil, 7.1 g/ft2; 30 mil, 9.5 g/ft2.
(i) Woven fiberglass fabric, 3.5 mil thick, 6.3 g/ft2 (weight).

The present invention thus uses structural, coated laminates for the protection of combustible (e.g., wood based) substrates during a fire event. It solves the critical problems of both eliminating or minimizing combustion while maintaining structural integrity. The laminates chosen are carefully selected to provide the desired structural properties, ability to convey select additives in a targeted, cost-effective manner and be compatible with a manufacturing process that uses heat and pressure. The present application uses non-cellulosic treatments with, in some cases, naturally fire-resistant or non-combustible materials.

This stands in contrast to prior art processes, where the approach relies on blending additives within the combustible substrate (e.g., wood strands) or utilizing a coated or saturated cellulose-based overlay that is not suitable for exterior exposure applications. The present invention does not blend the additives with the strands (in all or select layers). The present invention does not use solutions (e.g., borates, phosphates) that are pressure treated into a cellulose matrix (e.g., the wood). The present invention uses naturally fire-resistant and combustion-resistant additives that are placed in select locations (e.g., on or near the outside face of a siding/trim product) using a conveying mechanism as described above (e.g., laminate, fabric). The conveying mechanism may be coated or covered with the additives providing the FR protection, and may be located on the top face, bottom face, or both. The conveying laminate also may offer some FR protection itself.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A method of producing a fire-resistant (FR) wood composite product, comprising the steps of:
treated wood strands with chemicals, wherein the chemicals do not include fire-resistant or fire-retardant chemicals;
forming one or more layers of a strand mat with said treated wood strands;
placing a first FR-additive conveying laminate on the strand mat;
applying pressure and heat by a primary press to the strand mat and conveying laminate to form a board; and
processing the board to form one or more FR wood composite products.

2. The method of claim 1, wherein the FR wood composite products are oriented strand board panels.

3. The method of claim 1, wherein the FR-additive conveying laminate comprises a pre-applied FR-additive applied to the conveying laminate prior to placing the FR-additive conveying laminate on the strand mat.

4. The method of claim 1, further comprising the step of applying a first FR-additive to the first FR-additive conveying laminate after the step of placing the placing the FR-additive conveying laminate on the strand mat and before the step of applying pressure and heat by a primary press.

5. The method of claim 1, further comprising the step of applying a second FR-additive conveying laminate on the first FR-additive conveying laminate before the step of applying pressure and heat by a primary press.

6. The method of claim 5, wherein the first FR-additive conveying laminate and the second FR-additive conveying laminate comprise different materials.

7. The method of claim 5, wherein the first FR-additive conveying laminate and the second FR-additive conveying laminate comprise the same material.

8. The method of claim 1, further comprising the step of placing a bottom FR-additive conveying laminate on a forming line prior to the step of forming one or more layers of a strand mat.

9. The method of claim 1, wherein the FR-additive conveying laminate comprises fiberglass.

10. The method of claim 1, wherein the FR-additive conveying laminate comprises a non-woven polymer.

11. The method of claim 1, wherein the FR-additive conveying laminate comprises a cellulose material.

12. The method of claim 1, wherein the FR-additive conveying laminate comprises a mesh.

13. The method of claim 1, wherein the FR-additive conveying laminate provides resistance to combustion and resistance to flame spread across the surface of the product during a fire event.

14. The method of claim 13, wherein the FR-additive conveying laminate provides resistance to loss of structural integrity in the wood strand substrate portion of the product during a fire event.

15. An integrated wood composite panel with FR-additive conveying laminate produced according to the method of claim 1.

16. An integrated multi-layer wood composite panel or board, comprising:
one or more layers of engineered wood strands that have not been treated with fire-retardant or fire-resistant additives;
a first fire retardant or fire resistant (FR) additive conveying laminate disposed on an upper surface of the wood strand layer or layers;
a fines layer disposed on the FR additive conveying laminate; and
an overlay layer disposed on an upper surface of the fines layer.

17. The panel or board of claim 16, further comprising a bottommost FR additive conveying laminate disposed on the lower surface of the wood strand layer or layers.

18. The panel or board of claim 16, further comprising a second FR additive conveying laminate disposed between the first FR additive conveying laminate and the overlay layer.
